(19) United States
(12) Patent Application Publication
(10) Pub. No.: US 2001/0022480 A1
(43) Pub. Date: Sep. 20, 2001

(54) Rotor for a DC machine and process for its production

(76) Inventors: Hans-Jurgen Johann, Friedrichsdorf (DE); Andre Kissling, Unterentfelden (CH)

Correspondence Address: Martin A. Farber, Suite 473, 866 United Nations Plaza, New York, NY, 10017, US

(21) Appl. No.: 09/745,178

(22) Filed: Dec. 20, 2000

(30) Foreign Application Priority Data
Dec. 23, 1999 (DE) 199 62 821.1

(51) Int. Cl. H02K 1/06

(52) U.S. Cl. 310/217

(57) ABSTRACT

A rotor for a DC machine has on a motor shaft a stator core which is formed by a multiplicity of armature laminations (2). These armature laminations (2) each have a locating bore (3) which is arranged slightly eccentrically in the armature lamination (2). The individual armature laminations (2) of the armature core (1) or groups of armature laminations (2) are arranged such that they are turned in relation to one another by at least one pole pitch.

The invention relates to a rotor for a DC machine which has a multiplicity of armature laminations axially one behind the other, which are provided with a locating bore and are connected undisplaceably to one another by holding means to form an armature core, which as a whole is pushed onto a motor shaft.

Rotor cores of the aforementioned type are very widely used for DC machines, for example for servo motors in a motor vehicle, and are therefore generally known. The individual armature laminations of the armature core must be locked on the motor shaft to prevent them from turning. It is therefore necessary for relatively close tolerances to be maintained in the diameter of the motor shaft and the locating bore in the respective armature laminations, in order that the armature core can be pushed snugly onto the motor shaft. In practice, the motor shaft is provided with a knurl. This knurl presses into the lateral surface of the locating bores when the armature core is pushed on, and consequently forms a means of preventing turning for the armature core. Furthermore, the knurl has the effect of reducing the proportion of the motor shaft bearing the locating bores, as a result of which the pushing on of the armature core is facilitated.

A disadvantage of the known rotor is that producing the motor shaft with a knurl is complex and expensive and significantly influences the total production costs of a motor with such a rotor.

The invention is based on the problem of designing a rotor of the type stated at the beginning in such a way that its armature core can be reliably pushed onto the motor shaft without the risk of the individual armature laminations turning on the motor shaft and without undesirably close tolerances having to be maintained. Furthermore, a process for producing such a rotor is to be provided.

The first-mentioned problem is solved according to the invention by the locating bore of each armature lamination being arranged slightly eccentrically in the armature lamination and by the individual armature laminations of the armature core or groups of armature laminations being arranged such that they are turned in relation to one another by at least one pole pitch.

This eccentric arrangement of the locating bores achieves the effect that the locating bore of each individual armature lamination touches the motor shaft only over a relatively small region. This reduces the bearing proportion of the entire locating bore of the armature core, so that a similar effect occurs with respect to the tolerances as with a uniform bore and a knurled shaft. Since, according to the invention, the bearing proportion is reduced by the forming of the locating bore and the turning of the individual armature laminations, it may be provided according to a development of the invention that the motor shaft is of a smooth form. It is also possible of course to use a knurled motor shaft and, in addition, eccentric locating bores. Then, particularly great tolerances are possible. A contoured hole could also be provided in each armature lamination instead of the eccentric locating bores, which would be more complex however and would exclude the possibility of the individual armature laminations being able to yield.

A particularly advantageous development of the invention comprises each armature lamination being arranged on the motor shaft such that it is turned with respect to the adjacent armature lamination by 45°. In the case of such an armature core, the bearing regions of individual armature laminations run helically along the motor shaft.

The second-mentioned problem, that of providing a process for producing a rotor for a DC machine in which armature laminations are in each case stamped with a locating bore and are subsequently connected to one another by pack-stacked stamping to form an armature core, is solved according to the invention by the locating bore in each case being stamped slightly eccentrically in the armature lamination and by the individual armature laminations of the armature core or groups of armature laminations being arranged before the pack-stacked stamping such that they are turned in relation to one another by at least one pole pitch.

With this procedure, it is possible to dispense with knurling on the motor shaft and nevertheless achieve the effect that the individual armature laminations are mounted on the motor shaft adequately firmly and such that they are secured against mutual turning.

The invention allows numerous embodiments. To illustrate them further, one of these is described below and is represented in the drawing, in which:

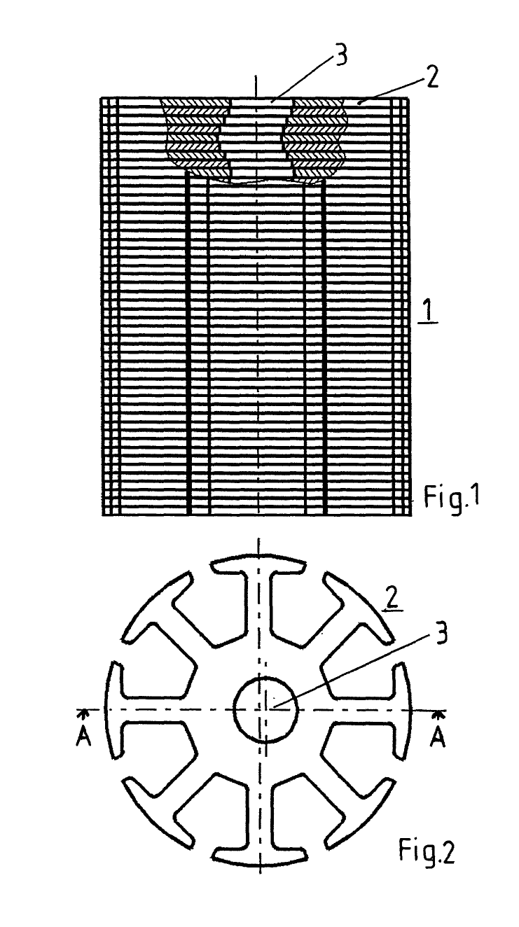

FIG. 1 shows a side view with a partial section of an armature core according to the invention,

FIG. 2 shows a plan view of an individual armature lamination.

FIG. 1 shows an armature core 1, with a partial section along the line AA from FIG. 2, which comprises a multiplicity of armature laminations 2 connected to one another by pack-stacked stamping. It can be seen in the section that locating bores 3 of the neighboring armature laminations 2 are laterally offset.

As FIG. 2 shows, each armature lamination 2 has a locating bore 3, which is arranged slightly eccentrically with respect to the center of the armature lamination 2. Eight poles 4 of the armature lamination 2 can likewise be seen in FIG. 2. In the case of the armature lamination 2 shown in FIG. 2, the locating bore 3 is offset to the right, as seen in the drawing; its eccentricity is thus directed to the right.

If the armature core 1 is formed with such armature laminations 2, the armature lamination located under the armature lamination 2 according to FIG. 1 is turned by 45°, so that its eccentricity is directed downward, as seen in the drawing. Each further armature lamination 2 is, in turn, arranged such that it is turned by 45°. The eccentricity then proceeds in jumps of 45° along a helix, which is indicated by the partial section in FIG. 1.

1. A rotor for a DC machine which has a multiplicity of armature laminations axially one behind the other, which are provided with a locating bore and are connected undisplaceably to one another by holding means to form an armature core, which as a whole is pushed onto a motor shaft, wherein the locating bore (3) of each armature lamination (2) is arranged slightly eccentrically in the armature lamination (2) and wherein the individual armature laminations (2) of the armature core (1) or groups of armature laminations (2) are arranged such that they are turned in relation to one another by at least one pole pitch or the locating bore is formed as a contoured locating hole.

2. The rotor as claimed in claim 1, wherein the motor shaft is of a smooth form.

3. The rotor as claimed in claims 1 or 2, wherein each armature lamination (2) is arranged on the motor shaft such that it is turned with respect to the adjacent armature lamination (2) by 45°.

4. A process for producing a rotor for a DC machine in which armature laminations are in each case stamped with a locating bore or contoured locating hole and are subsequently connected to one another by pack-stacked stamping to form an armature core, wherein the locating bore is stamped slightly eccentrically in the armature lamination and wherein the individual armature laminations of the armature core or groups of armature laminations are arranged before the pack-stacked stamping such that they are turned in relation to one another by at least one pole pitch.
